(19) United States
(12) Patent Application Publication
(10) Pub. No.: US 2008/0167955 A1
(43) Pub. Date: Jul. 10, 2008

(54) LOCATION BASED ADVERTISING AND TRAFFIC WARNING SYSTEM

(76) Inventors: Richard David Zerod, Chelsea, MI (US); Nazih Kamal Hijaouy, Plymouth, MI (US)

Correspondence Address: VISTEON, C/O BRINKS HOFER GILSON & LIONE, PO BOX 10395, CHICAGO, IL, 60610, US

(21) Appl. No.: 11/620,211

(22) Filed: Jan. 5, 2007

(51) Int. Cl. G06Q 30/00; G01S 5/00

(52) U.S. Cl. 705/14; 701/213

(57) ABSTRACT

A system and method for providing a user with traffic and sponsor information. The system generally includes a processor, traffic and location antennas in communication with the processor, a traffic location table database in communication with the processor, and a memory unit in communication with the processor and having processor executable instructions. The method includes the steps of saving a set of locations, determining at least one area of interest, receiving the traffic and sponsor message and outputting the sponsor and traffic message to the output device if the sponsor location is within a specific distance from the user and the traffic location is located within the area of interest.

### BACKGROUND

1. Field of the Invention

The present invention generally relates to systems and methods for providing location based advertising and automobile traffic information to a driver of an automobile.

2. Description of the Known Technology

The number of automobiles found on roads has increased remarkably. Because of this increase and the difficulty and expense of providing additional roads to accommodate the increase of automobiles, the amount of automobile traffic has substantially increased. In order to avoid traffic congestion, drivers of automobiles have been provided traffic information in numerous ways. The most common way of providing traffic information to drivers is via audio broadcasts on AM/FM radio stations. Typically, radio stations broadcasting traffic information do so at designated intervals. For example, some radio stations may provide traffic information every fifteen minutes. Between the traffic information broadcasts, the radio station provides its standard programming. Other methods for receiving traffic information are available over the Satellite Digital Audio Radio Service (SDARS). Both XM and Sirius Satellite Radio have dedicated audio channels which provide traffic information for numerous major cities.

Another way of providing traffic information to the driver is via a vehicle navigation system. A vehicle navigation system may be configured to receive traffic information on the data channel from an AM, FM, or satellite digital audio radio services, such as the XM and Sirius satellite radio services. Because the vehicle navigation system will automatically monitor incoming data for relevant traffic information, there is no need for the driver to constantly monitor a radio broadcast.

However, traffic information from an AM, FM, or a satellite digital audio radio service is commonly encrypted. A decryption key is only provided to those drivers who subscribe to a service that provides traffic information. Most subscription services require the driver to pay in monthly installments, similar to a utility bill. Alternatively, a lifetime subscription may be used where the driver pays a one-time fee for continued service over the anticipated life of the vehicle. This subscription requirement has discouraged many drivers from utilizing services that provide traffic information. Service providers could offer traffic information for free, however, the lack of revenue to these service providers would undoubtedly lead to either inferior traffic information or no traffic information at all.

Therefore, there is a need for a system and method for providing traffic information to a driver while providing a potential revenue stream to traffic information service providers.

### SUMMARY

In satisfying the above need, as well as overcoming the enumerated drawbacks and other limitations of the related art, the present invention provides a system and method for providing a driver with traffic and sponsor information. The system is generally to be installed within an automobile and includes a processor, an output device in communication with the processor, a data antenna in communication with the processor and a user location antenna in communication with the processor.

The data antenna configured to transmit a traffic message and a sponsor message to the processor. The traffic message has a traffic location code and a traffic incident code, while the sponsor message includes a sponsor location code and a sponsor name. The sponsor name may be a code used in conjunction with a look-up table or may be broadcast as the actual sponsor name in ASCII text or as a phonetic representation of the actual sponsor name. In order to identify the location of the system, the location antenna is configured to transmit location data to the processor. Finally, the traffic location table minimally includes a set of traffic location codes and their corresponding latitude and longitude, a description of each traffic location code, and a direction indicator for each traffic location code.

The memory unit includes instructions executable by the processor that configure the processor to determine an area of interest, convert the traffic location code and the sponsor location code to a latitudinal and longitudinal coordinates using the location table, and output the sponsor name and traffic message to the output device if the sponsor location is within a specific distance from the user location and the traffic location is located within the area of interest.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a system for providing a user with traffic information and sponsor information embodying the principles of the present invention; and

FIG. 2 is a flow chart of a method, embodying the principles of the present invention, for providing a user with traffic information and sponsor information.

### DETAILED DESCRIPTION

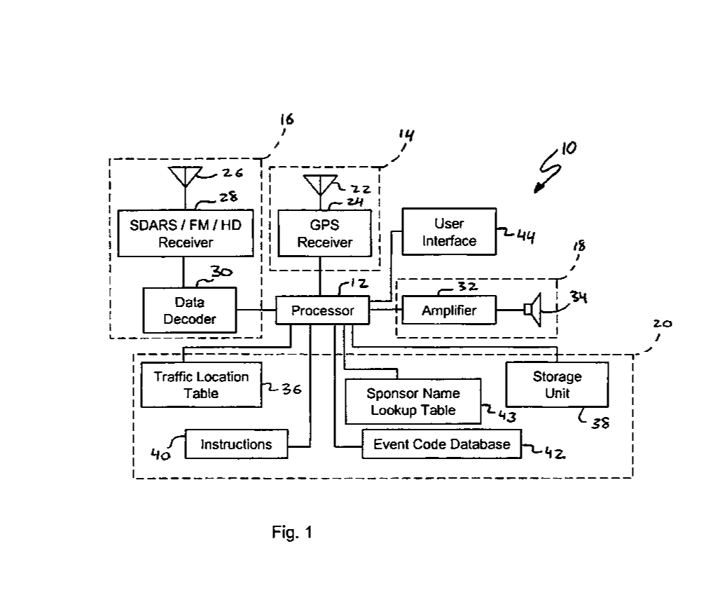

Referring to FIG. 1, a system embodying the principles of the present invention is illustrated therein and designated at 10. As its primary components, the system 10 includes a processor 12 in communication with an automobile location system 14, a traffic messaging system 16, an output system 18, and a storage system 20. As it is well known in the art, the processor 12 may be a “system on a chip” integrating one of more of the automobile location system 14, traffic messaging system 16, output system 18, and storage system 20.

The automobile location system 14 is a global positioning system (“GPS”) based system. The automobile location system 14 thus has a GPS antenna 22 capable of receiving GPS signals and communicating those signals to a GPS receiver 24. The received signals are generated by a plurality of GPS satellites and the automobile location system 14 is able to determine the position of the system 10, and therefore the automobile, by triangulating the received GPS signals. During operation of the system 10, the GPS receiver 24 may continually or intermittently provide the location of the system 10 to the processor 12.

The traffic messaging system 16 includes a traffic messaging antenna 26 in communication with a traffic receiver 28. The traffic messaging antenna 26 will receive signals containing automobile traffic data, such as location of traffic location data and traffic incident type. (The traffic incident type identifies the cause of the traffic, such as an accident, immobilized vehicle, and road construction.) These automobile traffic data signals may be generated as a sub-carrier from traditional FM stations, generated from a High Definition (HD) Radio station, or may be generated from satellite digital audio radio services such as XM and Sirius. The traffic receiver 28 provides these incoming signals to a data decoder 30 that processes the received traffic signals and provides the traffic data to the processor 12.

In addition to receiving automobile traffic data, the traffic messaging antenna 26 will be capable of receiving a sponsor message. The sponsor message includes data indicating a sponsor location code and a sponsor name or sponsor code. The sponsor location code identifies the location of any sponsor, while the sponsor name identifies the name of the sponsor. The sponsor name may be the actual name of the sponsor or may be a sponsor name code, capable of being decrypted via the use of the sponsor name lookup table. For example, the sponsor name may be the name of a restaurant, such as a McDonald's restaurant, while the sponsor location will be the approximate location of the previously mentioned McDonald's restaurant.

Additionally, the sponsor message may contain additional information including a sponsor advertising time interval. As will be later described in more detail, the sponsor advertising time interval indicates a time period in which the sponsor name will be provided to the output device 18. By so doing, the sponsor name will only be provided to the output device 18 during the specified time period, which, for example, may be the operating hours of the sponsor.

The data decoder 30 will generally arrange the data received from the traffic receiver 28 in a manner that the processor 12 can process and may, among other things, decrypt the data received from the receiver 28. As will be appreciated by those skilled in the field of this technology, the data decoder 30 may be comprised of a combination of hardware and software where certain instructions may be executed by processor 12.

The output system 18 is generally an audio output system. Alternatively or additionally, output system 18 may include a display device. In the output system 18, any audio signals transmitted from the processor 12 are received by an amplifier 32. The amplifier 32 amplifies the audio signals, which detail traffic information relevant to the area of interest, and outputs the signal to the speaker 34, the output of which is heard by the occupant(s) of the automobile. The output system 18 may optionally be shared with other audio systems in the automobile, such as the AM/FM radio receiver or CD player. In this case, the audio signals transmitted from the processor 12 could temporarily interrupt and take precedence over the other optional audio sources and transmit the traffic information to the occupant(s) of the automobile. After transmission of the traffic information had been completed, the output system 18 could be utilized again by the optional audio sources. If the system 10 includes a display device, video or control signals from the processor 12 are displayed thereon for viewing by the occupant(s) of the automobile.

The storage device 20 includes a traffic location table 36, a storage unit 38, an instruction set 40, and an event code database 42. As will be appreciated by those skilled in the field of this technology, the storage system 20 may be a single storage device or may be multiple storage devices. Portions of storage system 20 may also be located on processor 12. Furthermore, the storage system 20 may be a solid state storage system, a magnetic storage system, an optical storage system or any other suitable storage system.

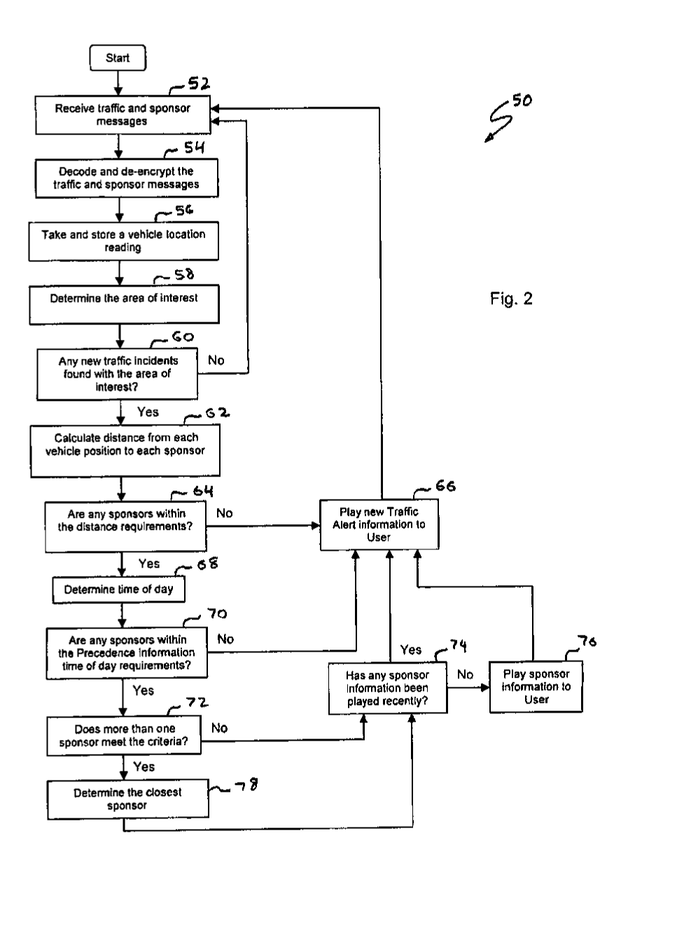

The traffic location table 36 contains a table having latitudinal and longitudinal coordinates corresponding to a variety of different road locations. As it is well known, map database and traffic location table manufacturers, such as the Navteq Corporation of Chicago, Ill., refer to road points using a customized numbering system. The traffic location table contains latitudinal and longitudinal coordinates corresponding to these road points. The instruction set 40, which may be embodied within any computer readable medium, includes processor executable instructions for configuring the processor to perform a variety of tasks, as will be later explained in connection with FIG. 2. The event code database 42 contains a description of the traffic event corresponding to the traffic event code. Finally, the storage unit 38 is a temporary storage unit that allows the processor 12 to temporarily store and retrieve data when required by the processor 12.

As stated previously, the sponsor name may be a sponsor name code, capable of being decrypted via the use of the sponsor name lookup table. An optional sponsor code name lookup table 43 contains a table having a list of sponsor names cross-referenced by a sponsor name code, thereby allowing the sponsor name code to be easily converted to an actual sponsor name.

Additionally, the system 10 may include a user interface 44 in communication with the processor 12. The user interface 44 allows a user to interact with the system 10. As will be described later, the user may be able to configure the processor 12 to output information to the output device 18 via a push button command.

Referring to both FIGS. 1 and 2, a method 50 for providing traffic messaging information and sponsor information according to an aspect of the invention will now be described. The method 50 is embodied in the instruction set 40 that is executed by the processor 12. In step 52, the traffic messaging system 16 receives an incoming traffic message and an incoming sponsor message. Thereafter, in step 54, the processor 12 decodes the incoming traffic message and an incoming sponsor message.

In step 56, the automobile location system 14 takes a location reading. This location reading is indicative of the location of the system 10 (and thus the automobile) and is stored within the storage unit 38. In step 58, the processor 12 calculates an area or radius of interest as determined from an input provided by the driver through a user interface 44, which corresponds to an area within a defined radius surrounding the location reading or an area in which the vehicle is likely to travel within. This area of interest will therefore include a plurality of latitudinal and longitudinal coordinates surrounding the location reading.

In step 60, the processor 12 parses the incoming traffic data to determine if there are any traffic incidents located within the area of interest. In order to accomplish this task, the processor 12 must convert the incoming traffic data to latitudinal and longitudinal coordinates. This is done by taking the incoming traffic data and looking up corresponding road location points in the traffic location table 36. If no traffic incidents are located within the area of interest, the method 50 returns to step 52. Otherwise, the method 50 proceeds to step 62.

In step 62, the processor 12 calculates the distance of any sponsors based on the sponsor locations in the sponsor message. In step 64, the processor 12 determines if any of the sponsors are within a specified distance from the vehicle. This specified distance may vary, based upon the application. If no sponsors are within the specified distance, the method 50 proceeds to step 66, wherein the traffic message is outputted to the output device 18. After step 66, the method returns to step 52.

If there are sponsor locations located within the specified distance, the method 50 proceeds to step 68, wherein the processor 12 determines the time of day. The processor 12 can determine the time of day via an internal clock or via clock signal received by the GPS antenna 22 or via the traffic messaging antenna 26. It is well known in the art that GPS signals include time of day data and RDS signals may include time of day data. In step 70, the processor 12 determines if the time of day is within a sponsor advertising time interval. If the time of day is not within the sponsor time interval, the method 50 proceeds to step 66, wherein the traffic message is outputted to the output device 18. Otherwise, the method 50 proceeds to step 72.

In step 72, the processor 12 determines if more than one sponsor fits the criteria previously described in steps 64 and 72. If only one sponsor fits this criteria, the method 50 proceeds to step 74, wherein the processor 12 determines if the sponsor name has been previously outputted to the output device 18. If so, the method 50 proceeds to step 66, wherein the traffic message is outputted to the output device 18. If not, the method first outputs the sponsor name to the output device 18, as shown in step 76, and then the traffic message is outputted to the output device 18, as shown in step 66. Alternatively, the method 50 may first output the traffic message before outputting the sponsor name.

In the event there are multiple sponsors that fit the criteria, the method 50 proceeds to step 78, wherein the processor 12 determines the closest sponsor to the vehicle location reading. From there, the method 50 proceeds to step 74, wherein the processor 12 determines if the closest sponsor name has been previously outputted to the output device 18. If so, the method 50 proceeds to step 66, wherein the traffic message is outputted to the output device 18. If not, the method first outputs the closest sponsor name to the output device 18, as shown in step 76, and then the traffic message is outputted to the output device 18, as shown in step 66.

Additionally, this embodiment contemplates that the user, via the user interface 44, can instruct the processor 12 to output the previously outputted traffic message and the sponsor name to the output device 18 via a push button command. This can be helpful to the user in situations where the user has forgotten the previously outputted traffic message or was distracted when the previously outputted traffic message was outputted.

Other embodiments consider the interval in which the sponsor name and traffic message is outputted. Conditions may exist where a previously unannounced the traffic message is played to the user without a sponsor name. For example, a timer may be utilized where the sponsor name is not played more frequently than in 10 minute intervals to minimize driver annoyance. For example, a determination may be made if the traffic message has been previously outputted to the output device and the sponsor name has been recently (determined by the timer) outputted to the output device. If, for example, a traffic message has been received that has not been outputted before and a sponsor name has not been outputted recently, both the sponsor name and the traffic message will be outputted. If a sponsor name has been recently outputted, then only the traffic message is outputted (assuming that the traffic message has not been outputted previously).

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A system for providing a user with traffic and sponsor information, the system comprising:
a processor;
an output device in communication with the processor;
a data antenna in communication with the processor, the data antenna configured to transmit a traffic message and a sponsor message to the processor, the traffic message having a traffic location code and a traffic incident code, the sponsor message having a sponsor location code and a sponsor name;
a user location antenna in communication with the processor, the user location antenna configured to transmit a user location to the processor, the user location being latitudinal and longitudinal location data;
a location table in communication with the processor, the location table having latitudinal and longitudinal location data corresponding to the traffic location code and the sponsor location code;
a memory unit in communication with the processor and having processor executable instructions for configuring the processor to:
receive the user location, the traffic message, and the sponsor message,
determine an area of interest,
convert the traffic location code and the sponsor location code to latitudinal and longitudinal coordinates using the location table;
output the sponsor name and traffic message to the output device if the sponsor location is within a specific distance from the user location and the traffic location is located within the area of interest.

2. The system of claim 1, wherein the memory unit includes processor executable instructions for configuring the processor to output the traffic message to the output device if the traffic location is located within the area of interest and the sponsor location is not located within the specific distance from the user location.

3. The system of claim 1, wherein the memory unit includes processor executable instructions for configuring the processor to:
determine if the traffic message has been previously outputted to the output device and the sponsor name has been recently outputted to the output device; and
output the traffic message and the sponsor name to the output device if the traffic event has not been previously outputted to the output device and the sponsor name has not been recently outputted to the output device.

4. The system of claim 1, wherein the sponsor message further comprises a sponsor advertising time interval and the memory unit includes processor executable instructions for configuring the processor to
receive a user time; and
output the traffic message and the sponsor name to the output device if the traffic location and the sponsor location is located within the area of interest and the user time is within a sponsor advertising time interval.

5. The system of claim 1, wherein the memory unit includes processor executable instructions for configuring the processor to
receive a replay signal from the user; and
output a previously outputted traffic message and sponsor name to the output device.

6. The system of claim 1, wherein the output device is an audio output device.

7. The system of claim 1, wherein the user location antenna is a global positioning system antenna.

8. The system of claim 1, wherein the area of interest is a plurality of latitudinal and longitudinal coordinates surrounding the user location.

9. A method for providing a user with traffic and sponsor information, the method comprising the steps of:
receiving a user location, a traffic message, a sponsor message;
the traffic message having a traffic location code and a traffic incident code, the sponsor message having a sponsor location code and a sponsor name,
determining an area of interest,
converting the traffic location code and the sponsor location code to latitudinal and longitudinal coordinates using a location table; and
outputting the sponsor name and traffic message to the output device if the sponsor location is within a specific distance from the user location and the traffic location is located within the area of interest.

10. The method of claim 9, further comprising the step of outputting the traffic message to the output device if the traffic location is located within the area of interest and the sponsor location is not located within specific distance from the user location.

11. The method of claim 9, further comprising the steps of:
determining if the traffic message has been previously outputted to the output device and the sponsor name has been recently outputted to the output device; and
outputting the traffic message and the sponsor name to the output device if the traffic event has not been previously outputted to the output device and the sponsor name has not been recently outputted to the output device.

12. The method of claim 9, further comprising the steps of:
receiving a user time;
output the traffic message and the sponsor name to the output device if the traffic location and the sponsor location is located within the area of interest and the user time is within a sponsor advertising time interval.

13. The method of claim 9, further comprising the steps of:
receiving a replay signal from the user; and
outputting a previously outputted traffic message and sponsor name to the output device.

14. The method of claim 9, wherein the output device is an audio output device.

15. The method of claim 9, wherein the area of interest is a plurality of latitudinal and longitudinal coordinates surrounding the user location.

16. In a computer readable storage medium having stored therein data representing instructions executable by a programmed processor for enabling operation of a system for providing a user with traffic information, the storage medium comprising instructions for:
receiving a user location, a traffic message, a sponsor message;
the traffic message having a traffic location code and a traffic incident code, the sponsor message having a sponsor location code and a sponsor name,
determining an area of interest,
converting the traffic location code and the sponsor location code to latitudinal and longitudinal coordinates using a location table; and
outputting the sponsor name and traffic message to the output device if the sponsor location is within a specific distance from the user location and the traffic location is located within the area of interest.

17. The computer readable storage medium of claim 16, further comprising instructions for outputting the traffic message to the output device if the traffic location is located within the area of interest and the sponsor location is not located within the specific distance from the user location.

18. The computer readable storage medium of claim 16, further comprising instructions for:
determining if the traffic message has been previously outputted to the output device and the sponsor name has been recently outputted to the output device; and
outputting the traffic message and the sponsor name to the output device if the traffic event has not been previously outputted to the output device and the sponsor name has not been recently outputted to the output device.

19. The computer readable storage medium of claim 16, further comprising instructions for:
receiving a user time; and
output the traffic message and the sponsor name to the output device if the traffic location and the sponsor location is located within the area of interest and the user time is within a sponsor advertising time interval.

20. The computer readable storage medium of claim 16, further comprising instructions for:
receiving a replay signal from the user; and
outputting a previously outputted traffic message and sponsor name to the output device.

21. The computer readable storage medium of claim 16, wherein the output device is an audio output device.

22. The computer readable storage medium of claim 16, wherein the area of interest is a plurality of latitudinal and longitudinal coordinates surrounding the user location.
